(19) United States
(12) Patent Application Publication
(10) Pub. No.: US 2012/0139204 A1
(43) Pub. Date: Jun. 7, 2012

(54) SUSPENSION SYSTEM FOR VEHICLE

(75) Inventor: Daewoo JUNG, Seongnam-si (KR)

(73) Assignees: Kia Motors Corporation, Seoul (KR); Hyundai Motor Company, Seoul (KR)

(21) Appl. No.: 13/188,828

(22) Filed: Jul. 22, 2011

(30) Foreign Application Priority Data
Dec. 6, 2010 (KR) 10-2010-0123558

(51) Int. Cl. B60G 21/055

(52) U.S. Cl. 280/124.106

(57) ABSTRACT

A strut type suspension system of a vehicle has the advantages of reducing a diameter of a stabilizer bar and improving a braking stability by disposing the stabilizer bar and a steering gear box at a front side. The suspension system includes a stabilizer bar and a steering gear box is fixed on a sub frame, wherein the stabilizer bar is disposed at a middle front portion between an upper panel and a lower panel forming the sub frame.

### CROSS-REFERENCE TO RELATED APPLICATION

This application claims priority to and the benefit of Korean Patent Application No. 10-2010-0123558 filed on Dec. 6, 2010, the entire contents of which application is incorporated herein for all purposes by this reference.

### BACKGROUND OF INVENTION

1. Field of Invention

The present invention relates to a suspension system of a vehicle. More particularly, the present invention relates to a strut type suspension system of a vehicle that a stabilizer bar and a steering gear box are disposed at a front side to improve a braking stability and an efficiency of a stabilizer bar such that a diameter thereof can be reduced.

2. Description of Related Art

A stabilizer bar that is applied in an independent suspension system of a vehicle is a kind of twist spring that suppresses a roll motion of a vehicle body when it turns or travels a rough road to maintain its balance.

A mounting method of the stabilizer bar includes a front side mounting method and a rear side mounting method in a sub frame.

In a case that the stabilizer bar is disposed by the front side mounting method, there is a merit that a turning stability is improved by a toe-out increment (under steer). However, since performance for fuel consumption and NVH (noise vibration harshness) is being emphasized recently and new type of systems such as rack assist motor driven power steering system and bearing roll rod are increased, it is impossible to realize the front side mounting method of the stabilizer bar.

As shown in FIG. 1 and FIG. 2, a stabilizer bar 2 and a steering gear box 4 is disposed on a sub frame 6, wherein the steering gear box 4 is disposed at a front side of the sub frame 6 and the stabilizer bar 2 is disposed at a rear side thereof, in a case that the stabilizer 2 is disposed at a rear side of the steering gear box 4 as the above, there is a problem to increase a diameter of the stabilizer bar so as to secure a roll rigidity equal to that of the stabilizer bar according to the front side mounting method.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a strut type suspension system of a vehicle having advantages of reducing a diameter of a stabilizer bar and improving a braking stability by disposing the stabilizer bar and a steering gear box at a front side.

A suspension system of a vehicle that a stabilizer bar and a steering gear box is fixed on a sub frame, wherein the stabilizer bar is disposed at a middle front portion between an upper panel and a lower panel forming the sub frame.

The stabilizer bar is disposed at a middle portion of the sub frame under the steering gear box that is fixed on the upper panel of the sub frame.

The stabilizer bar is fixed by a mount on an underside of the upper panel, which both sides of a middle portion thereof forms a sub frame.

The mount includes a rubber bushing that covers the stabilizer bar and contains lubricant element, and a bracket that covers the rubber bushing to be fixed on the upper panel.

In a suspension system according to various aspects of the present invention, the stabilizer bar and the steering gear box are disposed at a front side of a sub frame to secure a braking stability.

And, it is not necessary to increase a diameter of a stabilizer bar like a conventional rear side mounting method to improve a fuel consumption efficiency.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a top plan view showing a rear side mounting method of a conventional stabilizer bar.

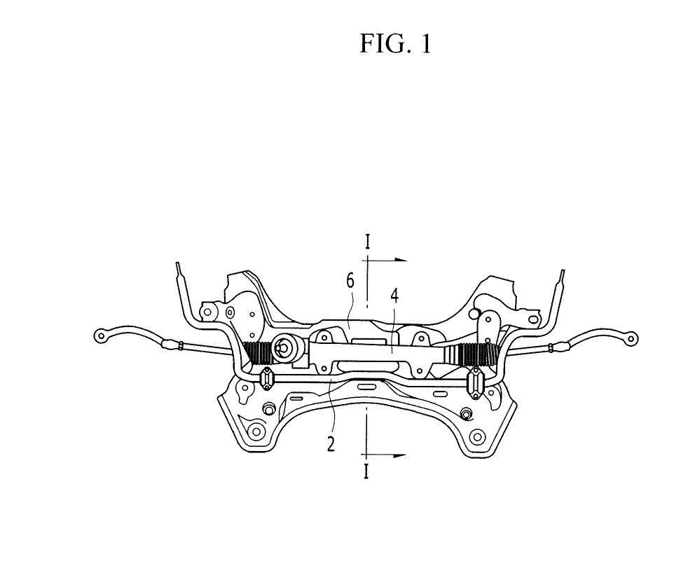

FIG. 2 is a cross-sectional view along a line I-I of FIG. 1.

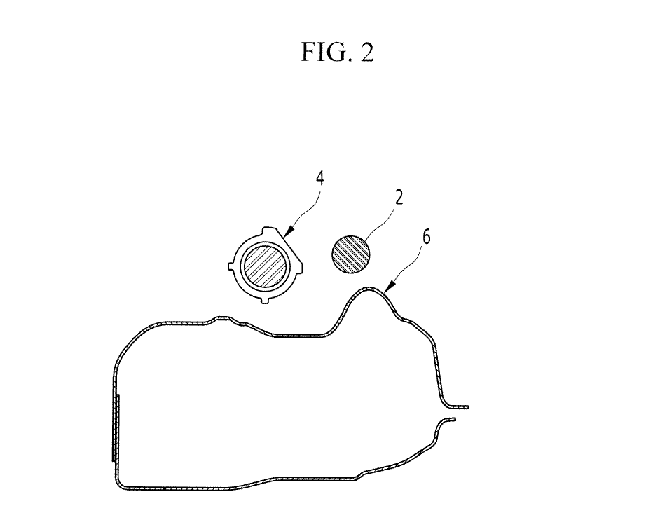

FIG. 3 is a top plan view showing an exemplary condition that a stabilizer is mounted according to the present invention.

FIG. 4 is a cross-sectional view along line II-II of FIG. 3.

FIG. 5 is a cross-sectional view showing an exemplary condition that a stabilizer bar and a sub frame are fixed according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The drawings and description are to be regarded as illustrative in nature and not restrictive. Like reference numerals designate like elements throughout the specification.

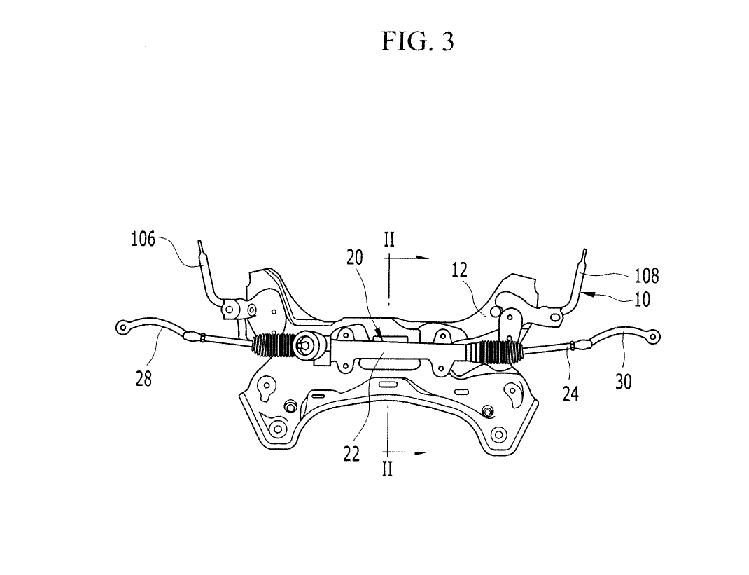

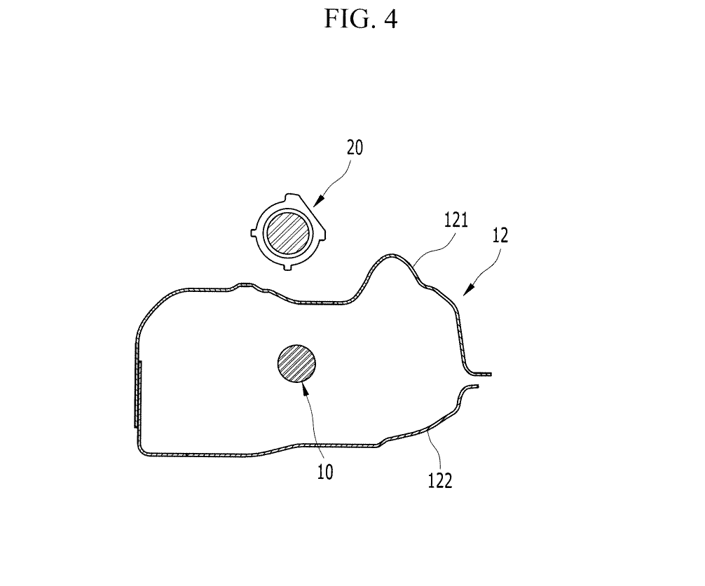

FIG. 3 is a top plan view showing a condition that a stabilizer is mounted according to various embodiments the present invention, and FIG. 4 is a cross-sectional view along line II-II of FIG. 3.

A stabilizer bar 10 is a type of a twist spring that is applied to a suspension system of a vehicle to suppress a roll motion of a vehicle body when a vehicle turns or travels on a rough road such that the vehicle body maintains its balance.

Both sides of a middle portion of the stabilizer bar 10 are fixed on a sub frame 12 by a fixation bushing, and a control link is disposed at both sides thereof to be fixed to a lower arm or a thrust of a suspension system so as to perform functions like the above.

And, a reference number 20 denotes a steering gear box, a tie rod 24 and 26 is connected to both sides of a rack bar that is disposed in a cylinder 22, the tie rod end 28 and 30 that are connected to both ends of the tie rod 24 and 26 are connected to a knuckle arm of a steering gear, and rotation direction of the steering gear is controlled by a steering wheel disposed around a driver's seat to realize a steering.

In a mounting the stabilizer bar 10 and the steering gear box 20, the present invention disposes the steering gear box 20 at an upper side of a front side of the sub frame 12, and the stabilizer bar 10 is fixed inside the sub frame 12 just under the steering gear box 20.

That is, as shown in FIG. 4, the sub frame 12 includes upper/lower panel 121 and 122 to form a space between them, and they are welded each other to have a box type.

In this case, after both sides of the sub frame 12 is opened, both end sides of the stabilizer bar 10 are exposed externally, and both sides of the middle portion of the stabilizer bar 10 is fixed on an underside of the upper panel 121.

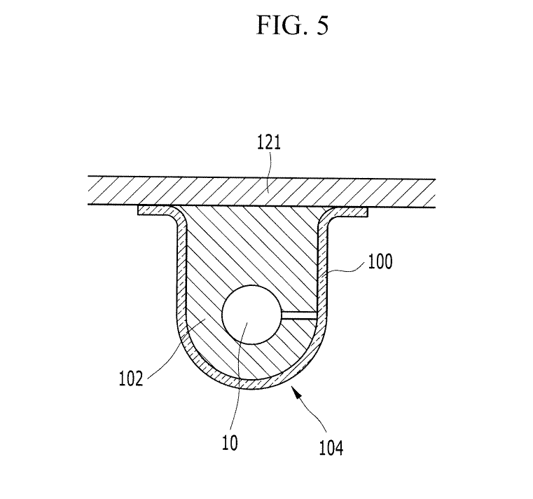

As shown in FIG. 5, a mount 104 is used to fix the stabilizer bar 10, the mount 104 includes a rubber bushing 102 containing lubrication material and a bracket 100, and the stabilizer bar 10 is inserted into a hole of the rubber bushing 102 and the bracket 100 encircles the rubber bushing 102 such that the stabilizer bar 10 is fixed on an underside of an upper panel 121 of the sub frame 21.

Accordingly, before welding the upper/lower panel 121 and 122 of the sub frame 12, the stabilizer bar 10 is fixed on an underside of the upper panel 121 and then the upper panel 121 and the lower panel 122 are welded.

So far, it has been described that the mount 104 includes the bracket 100 and the rubber bushing 102. However, it is not limited thereto and the mount 104 is one example of various kinds of mounts.

Since torsion is applied to the stabilizer bar 10 and both end sides 106 and 108 of the stabilizer bar 10 are exposed outwardly through openings of both sides of the sub frame 12, interference between the stabilizer bar 10 and the sub frame 12 is not formed.

Although the stabilizer bar 10 is fixed on an underside of the upper panel 121, it is not always biased to the upper panel 121, and it is desirable that the stabilizer bar 10 is spaced apart from the sub frame 12 by a predetermined distance such that the sub frame 12 is not interfered by the stabilizer bar 10 and the sub frame 12 fully functions.

As described above, in a case that the stabilizer bar 10 is mounted, the stabilizer bar 10 is disposed at a front side of the sub frame 12 along with the steering gear box 20 to secure a braking stability.

And, it is not necessary to enlarge a diameter of the stabilizer bar 10 to save the cost.

For convenience in explanation and accurate definition in the appended claims, the terms upper or lower, front or rear, inside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A suspension system of a vehicle comprising:
a stabilizer bar affixed on a sub frame;
a steering gear box is fixed on the sub frame; and
wherein the stabilizer bar is disposed at a middle front portion between an upper panel and a lower panel of the sub frame.

2. The suspension system of claim , wherein the stabilizer bar is disposed at a middle portion of the sub frame under the steering gear box that is fixed on the upper panel of the sub frame.

3. The suspension system of claim 1, wherein the stabilizer bar is fixed by a mount on an underside of the upper panel, which both sides of a middle portion thereof forms a sub frame.

4. The suspension system of claim 3, wherein the mount includes:
a rubber bushing that covers the stabilizer bar and contains lubricant element; and
a bracket that covers the rubber bushing to be fixed on the upper panel.
